(19) United States
(12) Patent Application Publication
(10) Pub. No.: US 2008/0200235 A1
(43) Pub. Date: Aug. 21, 2008

(54) SLOT MACHINE AND CONTROL METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/025,473

(22) Filed: Feb. 4, 2008

(30) Foreign Application Priority Data
Feb. 5, 2007 (JP) JP2007-025411

(51) Int. Cl. A63F 13/00

(52) U.S. Cl. 463/20

(57) ABSTRACT

A slot machine is provided with a CPU and a liquid crystal display having a plurality of display areas. In operation, the CPU performs a slot game on the liquid crystal display to select one symbol from among multiple kinds of symbols and display the selected symbol in each of the display areas. When symbols displayed in two or more display areas form a predetermined winning combination, the CPU changes a predetermined number of the symbols to special symbols advantageous to a player and further change symbols adjacent to the special symbols to special symbols advantageous to the player.

### CROSS REFERENCE TO RELATED APPLICATION

This application claims benefit of priority under 35 U.S.C. § 119 to Japanese Patent Application No. 2007-025411, filed on Feb. 5, 2007, the entire contents of which are incorporated by reference herein.

### BACKGROUND OF THE INVENTION

1. Field of the Invention

The present invention relates to a slot machine having a display unit and a control method of the slot machine.

2. Description of the Related Art

In a conventional slot machine, when a player inserts a predetermined number of medals into an insertion slot of the machine and further operates a start button, a plurality of reels (e.g. three reels) each having a plurality of symbols attached thereto start to rotate independently of each other. After the lapse of a predetermined time, these reels stop. Then, if respective symbols forming a designated winning combination or a predetermined number of scatter symbols happen to stop in a pre-set pay-line, the player is awarded with a payout corresponding to the number of inserted medal.

United States Patent Publication No. 2002/0,025,843 discloses a slot machine in which a plurality of reel images are displayed on a designated display area of a display unit, thus performing a movie displaying as if the so-displayed reel images rotated in the display area. In this field, there is such a conventional slot machine adopting a display form where a plurality of reel images are displayed so as to rotate in a designated area of a display unit.

Under the circumstances, there is recently desired an appearance of a slot machine providing a new entertainment in comparison with the conventional slot machine described above.

### SUMMARY OF THE INVENTION

Under the above-mentioned circumstance, it is therefore an object of the present invention to provide a slot machine capable of providing a player with improved entertainment and a control method of the slot machine.

In order to attain the above object, the present invention provides a slot machine which includes: a display unit on which a slot game is performed, wherein the slot game is programmed so that one symbol is selected from among multiple kinds of symbols and displayed in each of first display areas of the display unit; and a controller that performs the slot game on the display unit, wherein, when symbols displayed in two or more first display areas form a predetermined combination, the controller changes a predetermined number of the symbols to special symbols advantageous to a player and further changes symbols adjacent to the special symbols to special symbols advantageous to the player.

In the present invention, according to the situational change in the slot game, the special symbols advantageous to a player are arranged in the display unit, in concentration and succession. Consequently, the slot machine becomes possible to perform an effect display to raise a player's sense of anticipation for a winning in connection with the situational change in the slot game.

In the slot machine constructed above, preferably, the display unit has a second display area other than the first display areas on each of which the one symbol is displayed, and the controller displays a special symbol advantageous to the player on the second display area when an area adjacent to first display areas on which the predetermined number of the symbols are changed to the special symbols is positioned outside the first display areas.

In the above preferable form, according to the situational change in the slot game, the special symbols advantageous to the player are arranged over the first and second display areas of the display unit, in concentration and succession. Therefore, the slot machine becomes possible to perform the effect display to raise the player's sense of anticipation for the winning in connection with the situational change in the slot game.

In the slot machine constructed above, preferably, the controller shifts the slot game to a game advantageous to the player when a combination of symbols displayed on two or more first display areas fulfils a predetermined condition for shifting to the game advantageous to the player, and when symbols displayed on two or more first display areas form the predetermined combination in the game advantageous to the player, the controller randomly determines whether or not a predetermined number of the symbols are changed to special symbols advantageous to the player.

According to the preferable form mentioned above, the displayed symbols are changed to the special symbols in the game advantageous to the player and additionally, the symbols adjacent to the so-changed special symbols are also changed to the special symbols. Thus, the special symbols advantageous to a player are arranged in the display unit, in concentration and succession. In the slot game making the transition to the game advantageous to the player, the slot machine becomes possible to perform the effect display to raise the player's sense of anticipation for the winning in connection with the situational change in the slot game.

In the slot machine constructed above, preferably, the controller selects one symbol from among the multiple kinds of symbols and displays the one symbol in each of first display areas other than first display areas on which the symbols are changed to the special symbols, while maintaining the display of the special symbols.

According to the preferable form mentioned above, while maintaining a situation that the special symbols are arranged in the display unit in concentration and succession, the symbols displayed in the other first display areas are replaced with new symbols selected again. Once the special symbols advantageous to the player are arranged in concentration and succession, the slot game is advanced while maintaining the above arrangement. Thus, in the slot game making the transition to the game advantageous to the player, the slot machine becomes possible to perform the effect display to raise the player's sense of anticipation for the winning in connection with the situational change in the slot game.

In the slot machine of the present invention, preferably, the special symbols are symbols each playing respective roles of the multiple kinds of symbols.

According to the preferable form mentioned above, depending on the situational change in the slot game, the special symbols each having roles of multiple kinds of symbols are arranged in the display unit in concentration and succession. As a result of the arrangement, the slot machine becomes possible to perform the effect display to raise the player's sense of anticipation for the winning in connection with the situational change in the slot game.

In the above slot machine performing a further slot game while displaying the special symbols, preferably, the special symbols are symbols each playing respective roles of the multiple kinds of symbols.

According to the preferable form mentioned above, while maintaining a situation that the special symbols each playing roles of the multiple kinds of symbols are arranged in the display unit in concentration and succession, the symbols displayed in the other first display areas are replaced with new symbols selected again. Once the special symbols advantageous to the player are arranged in concentration and succession, the slot game is advanced while maintaining the above arrangement. Thus, in the slot game making the transition to the game advantageous to the player, the slot machine becomes possible to perform the effect display to raise the player's sense of anticipation for the winning in connection with the situational change in the slot game.

In order to attain the above object, the present invention further provides a slot machine which includes: a display unit on which a slot game is performed, wherein the slot game is programmed so that one symbol is selected from among multiple kinds of symbols and displayed in each of first display areas of the display unit and a winning occurs based on a combination of symbols displayed on a predetermined pay-line set through the first display areas; and a controller that performs the slot game on the display unit, wherein, when symbols displayed in two or more first display areas form a predetermined combination, the controller changes a predetermined number of the symbols to special symbols advantageous to a player and further changes symbols adjacent to the special symbols to special symbols advantageous to the player.

In the present invention, according to the situational change in the slot game, the special symbols advantageous to a player are arranged in the display unit, in concentration and succession. Consequently, the slot machine becomes possible to perform an effect display to raise a player's sense of anticipation for a winning in connection with the situational change in the slot game.

In the slot machine constructed above, preferably, the display unit has a second display area other than the first display areas on each of which the one symbol is displayed, and the controller displays a special symbol advantageous to the player on the second display area when an area adjacent to first display areas on which the predetermined number of the symbols are changed to the special symbols is positioned outside the first display areas.

In the above preferable form, according to the situational change in the slot game, the special symbols advantageous to the player are arranged over the first and second display areas of the display unit, in concentration and succession. Therefore, the slot machine becomes possible to perform the effect display to raise the player's sense of anticipation for the winning in connection with the situational change in the slot game.

In the slot machine of the present invention, preferably, the display unit has second display areas other than the first display areas on each of which the one symbol is displayed, and the controller displays a special symbol advantageous to the player on a second display area which is arranged in an extension direction of the pay-line when an area adjacent to first display areas on which the predetermined number of the symbols are changed to the special symbols is positioned outside the first display areas.

In the above preferable form, according to the situational change in the slot game, the special symbols are arranged over the first and second display areas of the display unit, in concentration and succession, and the special symbol(s) outside the first display areas are an extension of the pay-line. That is, as a new winning may be produced as the winning formed by the symbols arranged on the pay-line, the slot machine becomes possible to perform the effect display to raise the player's sense of anticipation for the winning in connection with the situational change in the slot game.

In the slot machine of the present invention, preferably, the display unit has second display areas other than the first display areas on each of which the one symbol is displayed, and the controller displays a special symbol advantageous to the player on a second display area through which a new pay-line is set when an area adjacent to first display areas on which the predetermined number of the symbols are changed to the special symbols is positioned outside the first display areas.

In the above preferable form, according to the situational change in the slot game, the special symbols are arranged over the first and second display areas of the display unit, in concentration and succession, and the special symbol(s) outside the first display areas are arranged in the area forming the new pay-line. Consequently, as a new winning may be produced by the symbols arranged on the new pay-line, the slot machine becomes possible to perform the effect display to raise the player's sense of anticipation for the winning in connection with the situational change in the slot game.

In the slot machine of the present invention, preferably, the controller shifts the slot game to a game advantageous to the player when a combination of symbols displayed in two or more first display areas fulfils a predetermined condition for shifting to the game advantageous to the player, and when symbols displayed on two or more first display areas form the predetermined combination in the game advantageous to the player, the controller randomly determines whether or not a predetermined number of the symbols are changed to special symbols advantageous to the player.

According to the preferable form mentioned above, the displayed symbols are changed to the special symbols in the game advantageous to the player and additionally, the symbols adjacent to the so-changed special symbols are also changed to the special symbols. Thus, the special symbols advantageous to a player are arranged in the display unit, in concentration and succession. In the slot game making the transition to the game advantageous to the player, the slot machine becomes possible to perform the effect display to raise the player's sense of anticipation for the winning in connection with the situational change in the slot game.

In the slot machine of the present invention, preferably, the controller selects one symbol from among the multiple kinds of symbols and displays the one symbol in each of first display areas other than first display areas on which the symbols are changed to the special symbols, while maintaining the display of the special symbols.

According to the preferable form mentioned above, while maintaining a situation that the special symbols are arranged in the display unit in concentration and succession, the symbols displayed in the other first display areas are replaced with new symbols selected again. Once the special symbols advantageous to the player are arranged in concentration and succession, the slot game is advanced while maintaining the above arrangement. Thus, in the slot game making the transition to the advantageous game to the player, the slot machine becomes possible to perform the effect display to raise the player's sense of anticipation for the winning in connection with the situational change in the slot game.

In the slot machine of the present invention, preferably, the special symbols are symbols each playing respective roles of the multiple kinds of symbols.

In the above preferable form, according to the situational change in the slot game, the special symbols advantageous to the player are arranged over the first display areas of the display unit, in concentration and succession. Therefore, the slot machine becomes possible to perform the effect display to raise the player's sense of anticipation for the winning in connection with the situational change in the slot game.

In the above slot machine performing a further slot game while displaying the special symbols, preferably, the special symbols are symbols each playing respective roles of the multiple kinds of symbols.

According to the preferable form mentioned above, the displayed symbols are changed to the special symbols in the game advantageous to the player and additionally, the symbols adjacent to the so-changed special symbols are also changed to the special symbols. Thus, the special symbols advantageous to a player are arranged in the display unit, in concentration and succession. In the slot game making the transition to the game advantageous to the player, the slot machine becomes possible to perform the effect display to raise the player's sense of anticipation for the winning in connection with the situational change in the slot game.

In order to attain the above object, the present invention further provides a control method of a slot machine comprising: performing a slot game in which one symbol is selected from among multiple kinds of symbols and displayed on each of display areas; changing a predetermined number of symbols displayed in two or more display areas to special symbols advantageous to a player when the symbols form a predetermined combination; and changing symbols adjacent to the special symbols to special symbols advantageous to the player.

According to the situational change in the slot game, the special symbols advantageous to the player are arranged in concentration and succession. Consequently, the slot machine becomes possible to perform an effect display to raise a player's sense of anticipation for a winning in connection with the situational change in the slot game.

These and other objects and features of the present invention will become more fully apparent from the following description and appended claims taken in conjunction with the accompany drawings.

### BRIEF DESCRIPTION OF THE DRAWINGS

FIG. 1A is an explanatory view showing an exemplary image displayed on a liquid crystal display unit of a slot machine in accordance with an embodiment of the present invention;

FIG. 1B is an explanatory view showing another exemplary image displayed on the liquid crystal display unit of the slot machine of the embodiment;

FIG. 1C is an explanatory view showing yet another exemplary image displayed on the liquid crystal display unit of the slot machine of the embodiment;

FIG. 2 is a perspective view of the slot machine in accordance with the embodiment of the present invention;

FIG. 3 is a schematic view showing respective pay-lines of the slot machine in accordance with the embodiment of the present invention;

FIG. 4 is a block diagram showing a control circuit of the slot machine in accordance with the embodiment of the present invention;

FIG. 5 is a schematic view showing respective memory areas of a RAM of the slot machine in accordance with the embodiment of the present invention;

FIG. 6 is a schematic view showing a payout table stored in a ROM of the slot machine in accordance with the embodiment of the present invention;

FIG. 7 is a schematic view showing another payout table stored in the ROM of the slot machine in accordance with the embodiment of the present invention;

FIG. 8A is a schematic view showing a changing pattern for special symbols stored in the ROM of the slot machine in accordance with the embodiment of the present invention;

FIG. 8B is a schematic view showing the changing pattern for special symbols stored in the ROM of the slot machine in accordance with the embodiment of the present invention;

FIG. 8C is a schematic view showing the changing pattern for special symbols stored in the ROM of the slot machine in accordance with the embodiment of the present invention;

FIG. 8D is a schematic view showing the changing pattern for special symbols stored in the ROM of the slot machine in accordance with the embodiment of the present invention;

FIG. 9 is a flow chart showing a slot gaming procedure of the slot machine in accordance with the embodiment of the present invention;

FIG. 10 is a flow chart showing a bonus gaming procedure of the slot machine in accordance with the embodiment of the present invention;

FIG. 11 is a flow chart showing the bonus gaming procedure of the slot machine in accordance with the embodiment of the present invention;

FIG. 12 is a schematic view showing a pay-line newly set in the slot machine in accordance with the embodiment of the present invention;

FIG. 13A is a schematic view showing a winning combination related to the pay-line of the slot machine in accordance with the embodiment of the present invention;

FIG. 13B is a schematic view showing another winning combination related to the pay-line of the slot machine in accordance with the embodiment of the present invention;

FIG. 13C is a schematic view showing yet another winning combination related to the pay-line of the slot machine in accordance with the embodiment of the present invention;

FIG. 14A is a schematic view showing a winning combination related to the pay-line of the slot machine in accordance with the embodiment of the present invention; and

FIG. 14B is a schematic view showing another winning combination related to the pay-line of the slot machine in accordance with the embodiment of the present invention.

### DETAILED DESCRIPTION OF THE PREFERRED EMBODIMENT

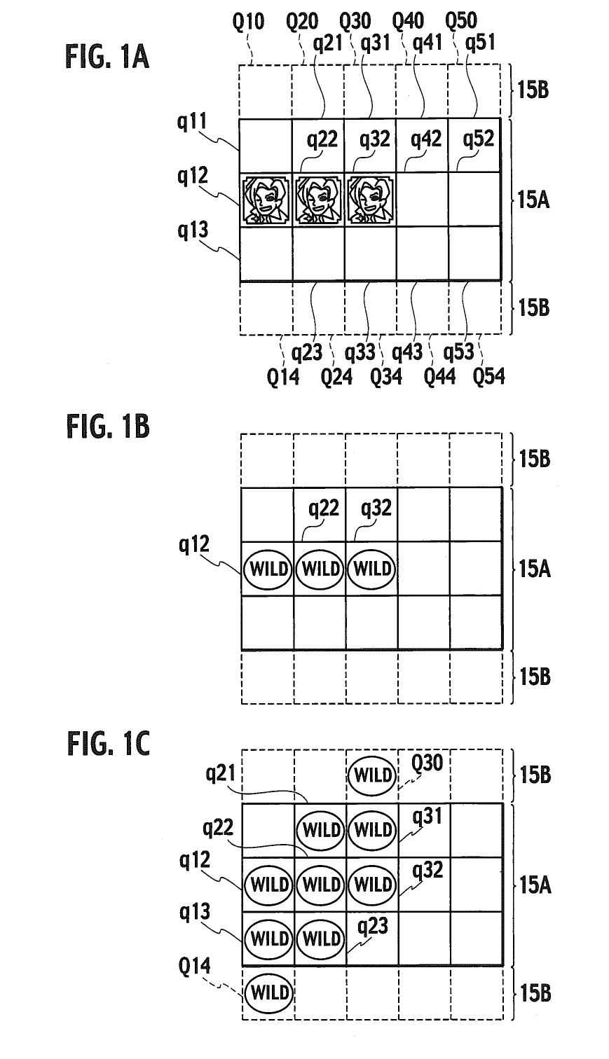

Referring to FIGS. 1A to 14B, an embodiment of the present invention will be described in detail.

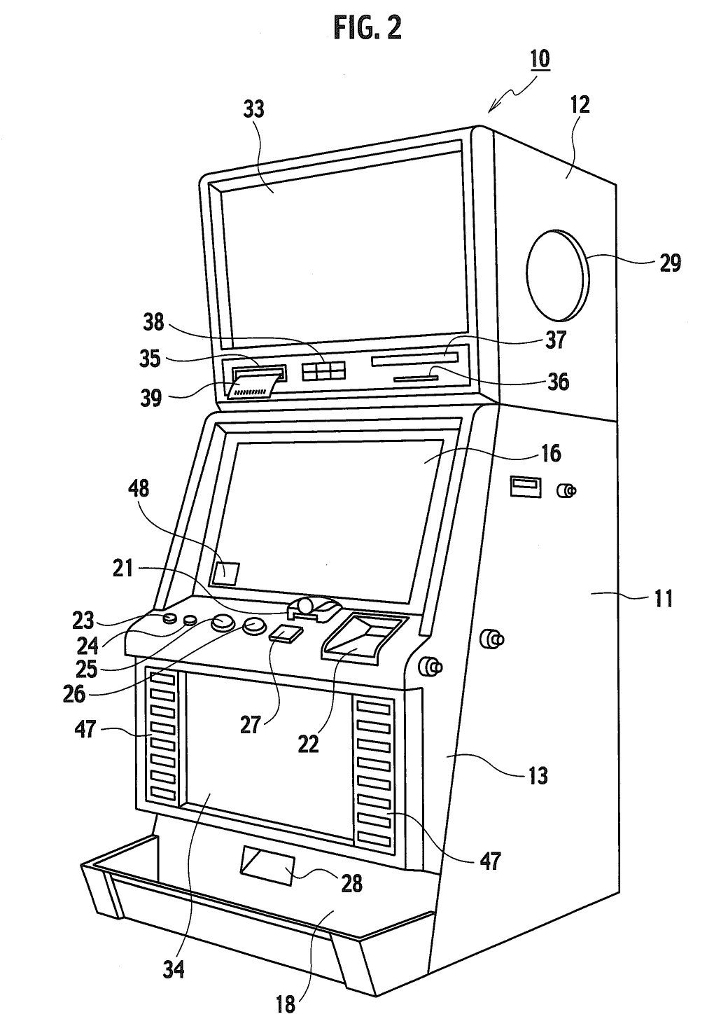

We first describe features of the embodiment of the present invention with reference to FIGS. 1A to 2. In the embodiment, a slot machine 10 includes a cabinet 11. The cabinet 11 is provided, on its front surface opposing a player (not shown), with a liquid crystal display 16 as the display unit of the invention. A plurality of display areas q11 to q13, q21 to q23, q31 to q33, q41 to q43 and q51 to q53 (see FIG. 1A) are defined in the liquid crystal display 16. In the shown embodiment, there are arranged fifteen display areas q11 to q53 in total, forming a matrix in three rows and five columns. In each of these display areas, there is performed a slot game of: selecting one symbol from a variety of symbols of multiple kinds; displaying the so-selected symbol in the corresponding display area; and producing a winning corresponding to a winning combination of these symbols stopped and displayed in the display areas. In the following description, an area consisting of fifteen display areas q11 to q53 for the slot game will be referred to as “first region 15A”, hereinafter.

In addition to the first region 15A consisting of the display areas q11 to q53, the liquid crystal display 16 includes display areas Q10, Q20, Q30, Q40, Q50, Q14, Q24, Q34, Q44 and Q54. The display areas Q10, Q20, Q30, Q40 and Q50 are positioned above the display areas q11, q21, q31, q41 and q51 forming an uppermost row of the first region 15A. The display areas Q14, Q24, Q34, Q44 and Q54 are positioned below the q13, q23, q33, q43 and q53 forming a lowermost row of the first region 15A. In the following description, an area consisting of these display areas Q10 to Q50 and Q14 to Q54 above and below the first region 15A will be referred to as “second region 15B”, hereinafter. In the shown embodiment, all the display areas forming the first region 15A and the second area 15B are arranged in different zones of an identical display screen of the liquid crystal display 16. However, the present invention is not limited to this arrangement only and, for example, they may be arranged in separate liquid crystal displays.

In the slot game performed by the liquid crystal display 16, as shown in FIGS. 1A to 1C, multiple kinds of symbols are displayed in each of the display areas q11 to q53 of the first region 15A in sequence (referred to as “variable display” hereinafter) and thereafter, one selected from these symbols is stopped and displayed with respect to each display area. If symbols stopped and displayed in the respective display areas form a predetermined combination (see FIG. 1A), it is determined whether or not to change a predetermined number of symbols stopped and displayed in the display areas to special symbols advantageous to a player (shown with characters “WILD” in FIG. 1B). When the symbols are changed to the special symbols as a result of the determination, other symbols adjacent to the special symbols are further changed to the same special symbols advantageous to the player (also shown with “WILD” in FIG. 1C). In the illustrated embodiment, symbols on either or both sides of the originating special symbols in the vertical direction of the display 16 are changed to the special symbols, as shown in FIG. 1C. In FIGS. 1A to 1C, it is assumed that the other kinds of symbols are stopped and displayed in respective blank display areas (shown with solid lines) of the first region 15A.

In the application, it is defined that the combinations of symbols are ones determined based on kinds of symbols stopped and displayed in respective display areas q11 to q53, for example, combinations in the kinds of symbols displayed in respective display areas q11 to q53 in the first region 15A or combinations in the sorts of symbols stopped and displayed on pay-lines set in the region 15A. As shown in FIG. 1A, if the specified symbols (i.e. bonus symbols) of a kind are arranged in respective display areas (i.e. display areas q12, q22, q32) in the second row and three columns from left straightly, in other words, the identical symbols are arranged in the second row successively by three from left, it is regarded that a predetermined winning combination has been effected. In the slot machine 10, various combinations are stored in an inside controller in advance. In the illustrated embodiment, there is no object about the kind of symbols displayed in the other display areas so long as the condition that three specified identical symbols are lined in the second row successively from left is satisfied. As for the positioning of display areas for a designated combination, the present invention is not limited to the illustrated positions and may be modified to other positions of the display areas.

We now present a concrete example of a game to change a predetermined number of symbols displayed in the display areas q11 to q53 of the first region 15A to special symbols advantageous to a player on condition that a predetermined combination is effected. In the embodiment, if a predetermined winning combination is realized, the specific symbols forming this winning combination are changed to special symbols advantageous to a player. In the slot machine 10 of the embodiment, it is assumed that if specific identical symbols (see FIG. 1A) are stopped and displayed in three successive display areas q12, q22 and q32, a predetermined winning combination is effected and continuously, these specific symbols “comic character” are changed to special identical symbols “WILD” as shown in FIG. 1B. While the embodiment is directed to the changing of the specific symbols forming the winning combination to the special symbols advantageous to a player, it is to be understood that the present invention is not limited to this, but some of other symbols stopped and displayed may be changed to special symbols.

In case of a predetermined winning combination, a controller of the slot machine 10 determines whether or not to change the stopped-and-displayed specific symbols to the special symbols advantageous to a player, at random. Assume, a program for randomly determining whether or not to change the specific symbols to the special symbols is previously stored in the controller of the slot machine 10. If it is determined to change the specific symbols to the special symbols, the controller of the slot machine 10 allows the liquid crystal display 16 to change a displaying of the specified symbols (see FIG. 1A) stopped and displayed in the areas q12, q22 and q32 in the first region 15A to a displaying of the special symbols, as shown in FIG. 1B. Depending on a result of the determination, of course, the specified symbols are not always changed to the special symbols in spited of the predetermined combination. Thus, this change to the special symbols provides an effect display representing a shifting from the normal gaming mode to a gaming mode advantageous to the player.

Once the specified symbols are changed to the special symbols in the display areas q12, q22 and q32, it is performed to change other symbols, which are stopped and displayed in other display areas adjacent to the areas q12, q22 and q32, to the same special symbols with no symbol varying and displaying. Changed to the special symbols in this embodiment are symbols that are stopped and displayed in the display areas on either or both sides of the display areas q12, q22 and q32 in the vertical direction. Such a propagation of the special symbols is controlled by the controller of the slot machine 10, which selects one of several propagation patterns stored in advance. As for the determination of which of adjacent display areas should be changed, alternatively, the CPU 106 may determine a direction of the propagation at random with respect to each change.

According to the embodiment, the slot machine 10 further operates to allow the other display areas (e.g. areas Q14 and Q30) neighboring the secondary-changed display area (e.g. areas q13, q21, q23 and q31) in either side in the vertical direction to display the special symbols. These display areas are determined by the controller of the slot machine 10, which selects one of several propagation patterns stored in advance.

In this way, by not only allowing the display areas (e.g. areas q13, q21, q23 and q31), which are adjacent to the display areas (e.g. areas q12, q22 and q32) changed to the special symbols initially, to display the special symbols, but also allowing the display areas (e.g. areas Q14 and Q30), which are adjacent to the display areas (e.g. areas q13, q21, q23 and q31) changed to the special symbols secondary, to display the special symbols, there is performed an effect display where the change to the special symbol is propagated in the display 16 up and down.

Suppose, the adjacent display area q31 above the display area q32 is changed to display the special symbol (see FIG. 1B). It is noted that display areas positioned above the display area q31 is out of the first region 15A. In this case, the special symbol is also displayed in the display area Q30 in the second region 15B out of the first region 15A (see FIG. 1C). Similarly, it is supposed that the adjacent display area q13 below the display area q12 is changed to display the special symbol (see FIG. 1B). It is noted that display areas positioned below the display area q13 is out of the first region 15A. In this case, the special symbol is also displayed in the display area Q14 in the second region 15B out of the first region 15A (see FIG. 1C).

In this way, according to the embodiment, since the other display areas Q10 to Q50 and Q14 to Q54 neighboring above and below the first region 15A are defined as the second region 15B for displaying the special symbols corresponding to the above effect display, it is possible to provide more impressive effect display where the change to the special symbols is further diffused over the first region 15A up and down.

Owing to the provision of the second region 15B where the display areas are successively arranged in the same direction as the display areas changing the specified symbols to the special symbols firstly, the change to the special symbols can be realized in a greater range of the display 16. Thus, when a predetermined combination is effected in the normal gaming mode, the special symbols are successively displayed in a display range centering on the display areas q12, q22 and q32 changing the specified symbols to the special symbols firstly.

In the embodiment, the special symbol serves as a so-called “almighty” symbol (“WILD” symbol in the figure) playing roles of the other symbols of multiple kinds. If the special symbols are displayed in concentration and succession in the slot game where a winning is produced corresponding to the kinds of symbols on the pay-line, the winning would be easy to be realized. That is, the successive and concentric arrangement of the special symbols causes an occurrence of the gaming situation advantageous to the player. Additionally, since the special symbols are displayed in not only originating display areas realizing a predetermined winning combination but also other display areas adjacent to the originating areas, a large number of symbols are changed to the special symbols in the display 16. Consequently, in the slot game where a winning is produced corresponding to the number of scatter symbols, the winning would be easy to be realized.

It follows that the increasing of the number of display areas for displaying the special symbols facilitates an occurrence of winning in both a slot game related to the pay-line and another slot game related to the scatter symbol.

In this way, if a predetermined winning combination of symbols is effected and additionally, some symbols stopped and displayed in the display unit at that time (e.g. some specified symbols realizing the predetermined winning combination) are changed to special symbols, there is successively initiated an effect that the change (transformation) for the special symbol spreads over the surrounding display areas in the circumstance. In such a case, a player would be strongly impressed by the transition for a new gaming situation advantageous to the player.

In the above-mentioned slot game, the symbol varying and displaying is carried out in each of the display areas q11 to q53 independently and thereafter, new symbols are stopped and displayed in some display areas. However, it is to be understood that the slot game related to the present invention is not limited to such symbol varying and displaying in the individual display areas q11 to q53. For instance, on the assumption of displaying each group of display areas q11 to q13, q21 to q23, q31 to q33, q41 to q43 and q51 to q53 as if it were a single reel, the slot machine may be constructed so as to perform a scroll displaying where respective reels rotate during play of the game.

The slot machine 10 of this embodiment will be described in detail. As shown in FIG. 2, the slot machine 10 includes the cabinet 11, a top box 12 arranged on the cabinet 11, and a main door 13. As noted above, the cabinet 11 is provided, on its front surface opposing a player, with the liquid crystal display 16. In the cabinet 11, a controller 40 (see FIG. 4) is provided to control the whole operation of the slot machine 10 electrically. The cabinet 11 further includes various constituents, such as a hopper 44 (see FIG. 4) to control insertion, reserving and payout of medals.

While the illustrated embodiment is directed to medal as gaming medium to be used in gaming, the present invention is not limited to this, but there may be cited, for example, coin, token, electronic money (digital money) or corresponding electronic valuable information (credit) as the other gaming media.

The main door 13 is attached to the cabinet 11 so as to open and close it. The liquid crystal display 16 is arranged at a substantial center of the main door 13. In the liquid crystal display 16, fifteen display areas q11 to q53 (see FIG. 1A) in total are arranged in three rows and five columns to display a variety of symbols. As soon as the slot game is started, the symbols varying and displaying is started in respective display areas. After the lapse of a predetermined time, the symbols varying and displaying is stopped throughout the display areas q11 to q53.

In the game using the slot machine 10, a winning (payout) is generated in accordance with the number of scatter symbols (mentioned later) included in the symbols stopped and displayed in the display areas q11 to q53 and the kind of symbols stopped and displayed on pay-lines.

In the liquid crystal display 16, a payout display area 48 is arranged in the vicinity of the lower left corner to display the number of payout medals at winning.

Below the liquid crystal display 16, there are arranged a medal insertion slot 21 through which a medal is inserted at playing the game and a bill validator 22 which determines whether an inserted bill is appropriate or not in order to accept normal bills. Various operating switches are arranged in the vicinity of the medal insertion slot 21 and the bill validator 22.

The operating switches comprise a cash out (payout) switch 23, a “MAXBET” switch 24, a “BET” switch 25, a spin repeat-bet switch 26 and a start switch 27.

The BET switch 25 is provided for a player to determine the number of credits at betting in the slot game performed by the slot machine 10. The player can place a bet by pushing the BET switch 25. The player can increase the bet by one credit (one medal) each time the player pushes the BET switch 25. The number of medals (credits) that the player has bet is stored in a later-mentioned RAM 110 (see FIG. 4) in the controller 40. The payout at winning is determined corresponding to the number of credits on bet and the number of scatter symbols stopped and displayed in the display areas. In the slot machine 10, the pay-lines are set corresponding to the number of credits on bet with respect to each game. The number of pay-lines increases as the number of credits on bet increases. The information about the so-set active pay-lines is stored in a pay-line storage area 110C of the RAM 110. As the winning (payout) is produced based on both a set (activated) pay-line and the kinds of symbols stopped and displayed on the pay-line, the larger the number of credits on bet gets, the higher the probability of the player's winning gets.

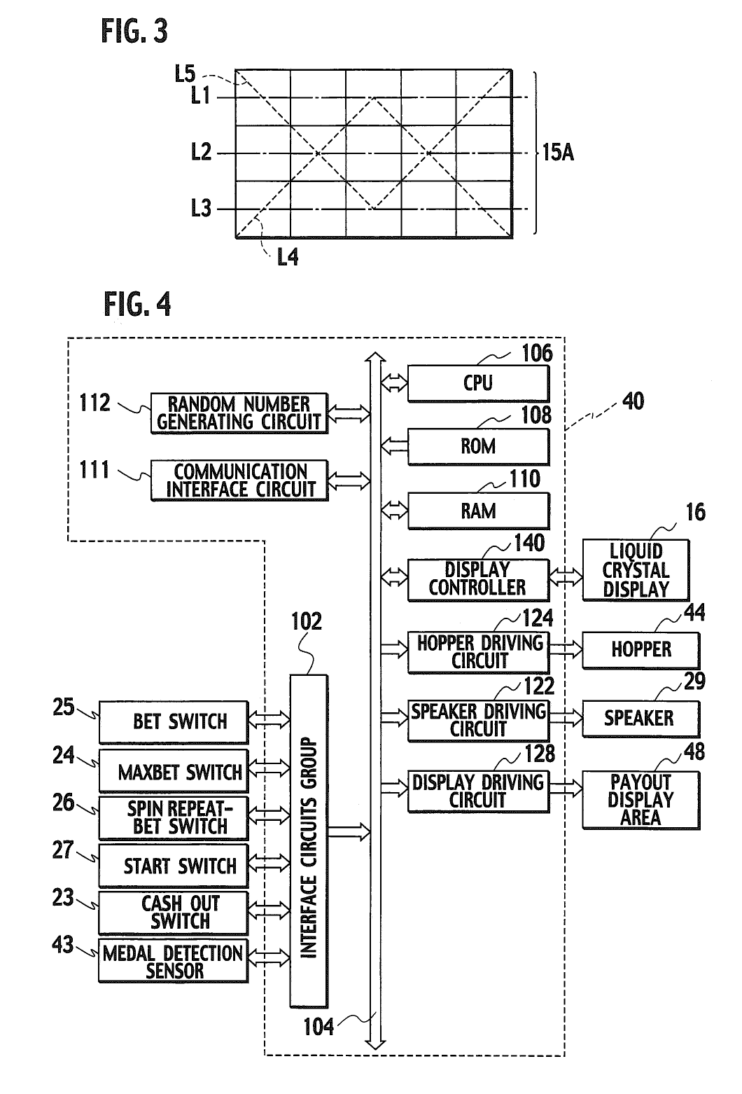

FIG. 3 is a schematic view showing the pay-lines in the first region 15A. According to the embodiment, the slot machine 10 has five pay-lines: a second pay-line L2 extending at the center of the first region 15A horizontally, a first pay-line L1 extending above the second pay-line L2 horizontally, a third pay-line L3 extending under the second pay-line L2, a fourth pay-line L4 intersecting obliquely to the second pay-line L2 in chevron and a fifth pay-line L5 intersecting obliquely to the second pay-line L2 in valley. The arrangement of these pay-lines L1 to L5 is stored in a ROM 108 of the controller 40.

In these pay-lines L1 to L5, a player can increase the number of active pay-lines by increasing the number of credits on bet. The order of activating the pay-lines in increment of one credit is as follow:

L2→L1→L3→L4→L5

The spin repeat-bet switch 26 is provided to enable a player to play the slot game without altering the number of credits that has been set in the previous game by using the BET switch 25.

The start switch 27 is provided for a player to start the slot game after betting a predetermined number of credits. Thus, when the start switch 27 is pushed after inserting the medal(s) into the medal insertion slot 21 or betting the predetermined number of credits through the BET switch 25, the slot game is started at the liquid crystal display 16.

The cash out switch 23 is provided to payout and receive a number of medals corresponding to remaining credits. The payout medals are discharged from a medal payout opening 28 in the lower front part of the main door 13 and further received in a medal payout tray 18.

The MAXBET switch 24 is provided to enable the slot game under the maximum number of credits (e.g. 30 medals) that the player can bet in one play, by a player's single action on the switch 24.

On the lower front of the main door 13, a foot display 34 is arranged to display a variety of images related to the game by the slot machine 10. For instance, image characters related to game contents by the slot machine 10 are displayed on the foot display 34.

On both sides of the foot display 34, lamps 47 are arranged so as to emit light based on a predetermined light-emitting pattern about the game play by the slot machine 10. The above medal payout opening 28 is positioned under the foot display 34.

The top box 12 is provided, on its front surface, with an upper display 33. The upper display 33 is equipped with a display panel that displays the information about payout numbers for respective combinations of symbols.

The top box 12 is also provided with a speaker 29 for generating game sounds. The top box 12 further includes a ticket printer 35, a card reader 36, a data display 37 and key pads 38 all positioned below the upper display 33. In operation, the ticket printer 35 prints out barcode data, such as the number of credits, date of play, ID (identification) number of the slot machine 10, in the form of a bar coded ticket 39.

By allowing the other slot machine to read out the bar coded ticket 39, a player can play a game with the other slot machine. Alternatively, at a predetermined spot of a game hall (e.g. casher in casino), the player can convert the bar coded ticket 39 to money (bills and coins).

The card reader 36 reads out data from a smart card (not shown) inserted thereinto or writes data to the smart card. Generally, the smart card is carried by a player, storing data for identifying the player, data about a player's playing history, etc.

FIG. 4 is a block diagram of the controller 40 and various instruments connected to the controller 40. In the slot machine 10 of this embodiment, the controller 40 is formed by a microcomputer and comprises a group of interface circuits 102 (referred to as “interface circuit group 102” after), an input/output (I/O) bass 104, a CPU 106, the ROM 108, the RAM 110, a communication interface circuit 111, a random number generating circuit 112, a speaker driving circuit 122, a hopper driving circuit 124, a display driving circuit 128 and a display controller 140.

The interface circuit group 102 is connected to the I/O bass 104 for inputting and outputting data signals or address signals for the CPU 106.

The start switch 27 is connected to the interface circuit group 102. The start signal generated from the start switch 27 is converted to a predetermined signal by the interface circuit group 102 and continuously transmitted to the CPU 106 through the I/O bass 104.

The BET switch 25, the MAXBET switch 24, the spin repeat-bet switch 26 and the cash out switch 23 are respectively connected to the interface circuit group 102. Respective switching signals generated from these switches 25, 24, 26 and 23 are supplied to the interface circuit group 102 and further converted to predetermined signals by the groups 102. Thereafter, the so-converted signals are transmitted to the CPU 106 through the I/O bass 104.

A medal detection sensor 43 is also connected with the interface circuit group 102 to detect a medal inserted into the medal insertion slot 21. The medal detection sensor 43 is arranged in a medal insertion part of the medal insertion slot 21. A detection signal generated from the medal detection sensor 43 is supplied to the interface circuit group 102 and converted to a predetermined signal by the group 102. Thereafter, the so-converted signals are transmitted to the CPU 106 through the I/O bass 104.

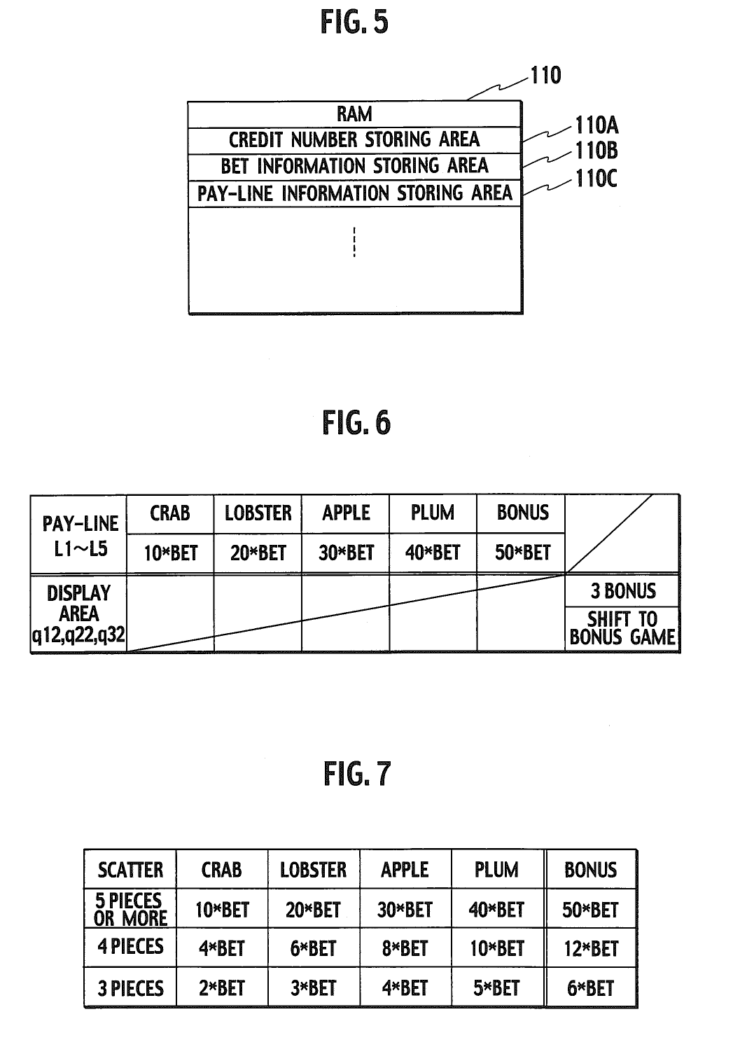

Connected with the I/O bass 104 are the ROM 108 that stores system programs and the RAM 110 that reserves various data. As shown in Fig. FIG. 5, the RAM 110 includes a credit-number storing area 110A for storing the number of credits possessed by a player, a bet information storing area 110B for storing the number of credits (bet information) bet by the player, a pay-line information storing area 110C for storing the information of pay-lines activated by the player and so on. The number of credits possessed by the player is renewed when the player bets a medal or medals to the slot machine 10 or certain winning combinations occur as a result of the slot game. The bet information is renewed at the player's betting the medal(s).

As shown in FIG. 7, a payout table about scatter symbols is stored in the ROM 108. The payout table shows the relationship between various conditions for paying out the medals and the numbers of medals paid out when the conditions are satisfied. The conditions for paying out the medals are represented by combinations of the symbols (stopped symbols) stopped and displayed in any of the display areas q11 to q53 with the number of stopped symbols. In the slot game of this embodiment, the CPU 106 determines whether or not the credits will be awarded (i.e. payout of medals or not) and the number of awarded credits (number of payout medals), based on the payout table of FIG. 7 and the kind of symbol stopped in each of the display areas q11 to q53. According to the illustrated payout table, for example, if five of more symbols “PLUM” stop in the display areas q11 to q53, then the number of payout medals amounts to 40 multiplied by the bet number (BET). The bet number indicates the number of medals that the player did bet in the relevant game play. In FIG. 7, “BONUS”, “PLUM”, “APPLE”, “LOBSTAR” and “CRAB” denote the names of symbols, respectively. In this slot game, these symbols are set as the scatter symbols.

In this way, the slot machine 10 of this embodiment is constructed so as to perform a slot game to generate a winning since the scatter symbols are stopped in the display areas q11 to q53, as well as the slot game to generate a winning since predetermined symbols of the same kind are stopped in the pay-lines, determining the number of medals (credits) to be paid out corresponding to the kinds of symbols stopped in the display areas q11 to q53 and the number of such symbols.

Additionally, the conditions of making the transition to a bonus game advantageous to the player are defined on another payout table (FIG. 6) about the pay-lines. That is, when a specified symbol “BONUS” is stopped in each of three successive display areas q12, q22 and q32 on the pay-line L2, the CPU 106 carries out a process of making the transition to the bonus game.

The ROM 108 stores, as weighted data, the corresponding relationship between code numbers representing respective symbols and one or more random numbers belonging to a predetermined numerical range (0 to 255) with respect to each display area q11 to q53. For instance, if there are defined a plurality of random numbers with respect to a certain symbol, the probability of selecting the same symbol is enhanced in comparison with a case that only one random number is defined against the same symbol. The weighted data is set on the ground of payout ratios of respective symbols (i.e. the payout tables of FIGS. 6 and 7). Besides the first weighted data used in the normal slot game, the embodiment prepares a second weighted data to be used in the bonus game.

The second weighted data is pre-set so that the probability of generating the winning combinations gets larger than that in the normal slot game. In this embodiment, the generation of winning combinations means that the symbols stopped and displayed include a predetermined number of scatter symbols or more scatter symbols and therefore, the second weighted data is pre-set so that the probability of selecting the scatter symbol gets larger. Thus, in the later-mentioned bonus game, the probability of the winning combination is enhanced due to the adoption of the second weighted data.

In case of changing to the bonus game, the CPU 106 determines whether or not to change the specified symbols (bonus symbols), which are successively stopped and display in three display areas q12, q22 and q32 on the lay-line L2 from left, to the special symbols advantageous to the player. In the slot game of the embodiment, if the specified symbols in the areas q12, q22 and q32 are changed to the special symbols in the bonus gaming mode, then there is performed an effect where such a transformation to the special symbols diffuses up to the surrounding display areas. That is, such a transformation of symbols from the specified symbols to the special symbols provides a player with an effect suggesting the transition to a gaming mode advantageous to the player thereafter.

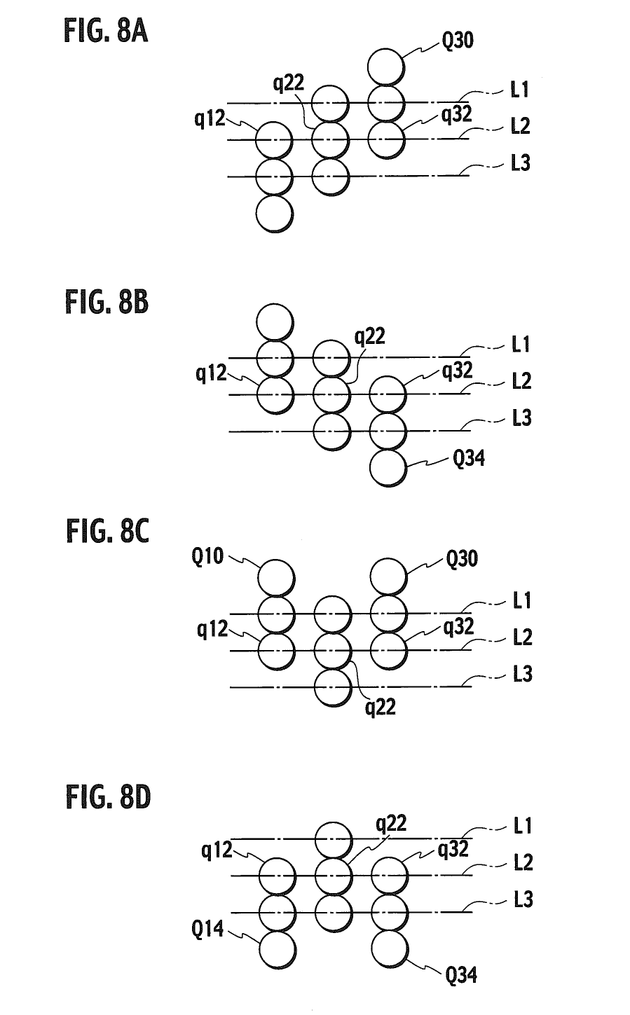

As shown in FIG. 1C, the slot machine 10 is adapted so that when the specified symbols changes to the special symbols, the transformation to the special symbols diffuses to any of the display areas surrounding the so-changed special symbols. This diffusion pattern is selected from a plurality of patterns stored in the ROM 108. FIGS. 8A to 8D schematically show these diffusion patterns stored in the ROM 108. Upon selecting one of these diffusion patterns, the CPU 106 changes the symbols in the display areas around the display areas q12, q22 and q32 to the special symbols in accordance with the selected diffusion pattern. In the illustrated embodiment, the patterns to be stored in the ROM 108 comprise four patterns shown in FIGS. 8A to 8D. The present invention is not limited to this, but other diffusion patterns (not shown) may be adopted in modifications.

On receipt of the signal from the start switch 27, the CPU 106 reads out a game execution program for executing a slot game and further carries out it. In accordance with the game execution program, the CPU 106 drives the display controller 140 to perform the slot game through the liquid crystal display 16.

This game execution program is programmed, in its part executing the normal slot game, so as to allow the respective display areas q11 to q53 to display variable symbols simultaneously, subsequently stop these symbols and generate a payout related to the activated pay-lines based on the pay-line information of FIG. 5 and the payout table of FIG. 6 and another payout related to the scatter symbols based on the payout table about the scatter symbol of FIG. 7. Additionally, the game execution program is programmed, in its part executing the bonus game, so as to, if the predetermined condition is satisfied, adopt the second weighted data facilitating displaying of the scatter symbols in abeyance and further change the scatter symbols to the special symbols, as shown in FIG. 1C.

The random number generating circuit 112, the communication interface circuit 111, the display controller 140, the hopper driving circuit 124, the speaker driving circuit 122 and the display driving circuit 128 are all connected to the I/O bass 104.

The communication interface circuit 111 is connected to a hall server etc. to transmit data (e.g. player's playing history about the slot machine 10) to the hall server and receive various data transmitted from the hall server.

The random number generating circuit 112 generates a random number to determine if generating a winning combination in the slot game using the liquid crystal display 16, a random number to determine if changing the specified (bonus) symbols to the special symbols and a random number to determine the diffusion pattern in changing the other symbols surrounding the so-changed specified symbols.

The display driving circuit 128 controls to display the number of payout on the payout display area 48 at the lower left corner of the liquid crystal display 16.

The speaker driving circuit 122 outputs audio signals (audio data) to the speaker 29. For this purpose, the CPU 106 reads out the audio data stored in the ROM 108 and transmits the same data to the speaker driving circuit 122 through the I/O bass 104. Then, the speaker 29 generates predetermined effect sounds related to the slot game.

In cases where the cash-out occurs, the hopper driving circuit 124 outputs payout signals to the hopper 44. When the cash-out signal is outputted from the cash-out switch 23, the CPU 106 outputs a drive signal to the hopper driving circuit 124 through the I/O bass 104. Consequently, the hopper 44 pays out a number of medals corresponding to the remaining credits stored in the predetermined memory area of the RAM 110 at that time.

The display controller 140 controls the operation of the liquid crystal display 16 in performing various effect displays corresponding to the slot game and its results. For this, the CPU 106 produces command signals for image displays corresponding to the present state in the slot game and the results and outputs these signals to the display controller 140 through the I/O bass 104. On receipt of the command signals from the CPU 106, the display controller 140 produces and outputs a drive signal to the liquid crystal display 16. Consequently, the effect images corresponding to the above-mentioned slot game shown in FIGS. 1A to 1C and the results are displayed on the liquid crystal display 16. Then, the CPU 106 operates to perform an effect where the images are displayed in the first region 15A and the second region 15B of the liquid crystal display 16 and further, the display area causing the symbols stopped and displayed to be changed to the special symbols is diffused from the first region 15A to the second region 15B.

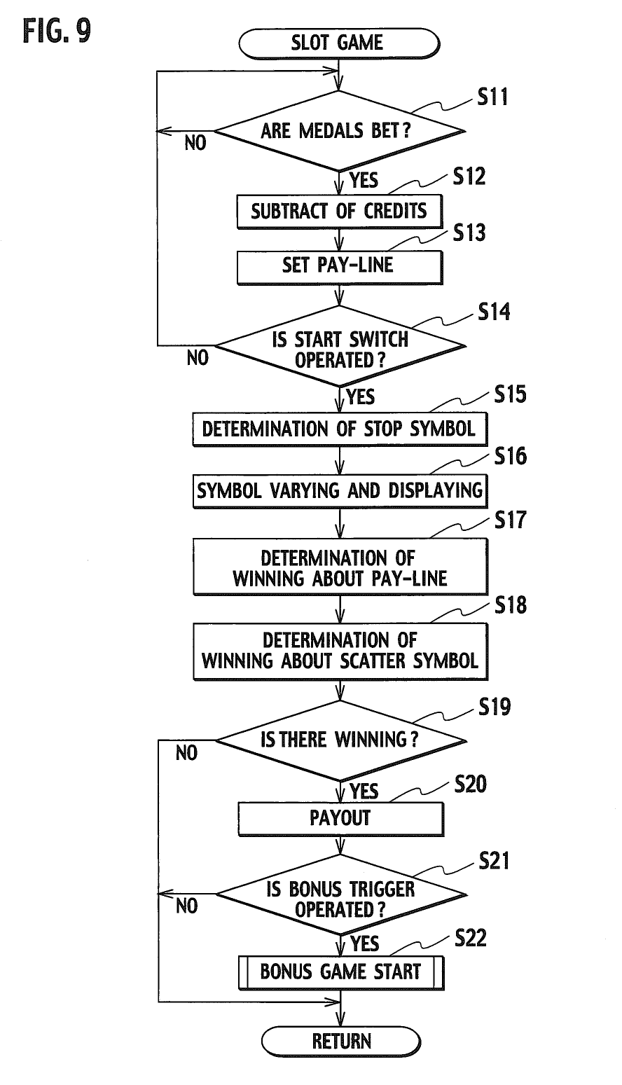

The operation of the slot machine 10 of this embodiment will be described with reference to FIGS. 9 to 11. In these figures, FIG. 9 is a flow chart showing the procedure of the slot game executed by the controller 40. According to the slot game program stored in the ROM 108, all the following steps are executed by the CPU 106.

In FIG. 9, at step S11, it is executed to determine whether the medal(s) have been bet by the player. In connection, it is also determined whether the CPU 106 has received either a signal from the BET switch 25 or another signal from the MAXBET switch 24. If it is determined that no medal has been bet, then the routine returns to step S11.

On the contrary, if the determination at step S11 is “Yes” (i.e. betting of medals), then the routine goes to step S12 to subtract the number of medals on bet from the number of credits stored in the RAM 110.

At next step S13, by the CPU 106, it is executed to set the pay-line based on the number of medals on bet at step S11. As previously mentioned with FIGS. 1A to 1C, as the number of medals on bet increases, the number of pay-lines is increased in order of L2→L1→L3→L4→L5.

At step S14, by the CPU 106, it is executed to determine whether the start switch 27 has been pushed down by the player or not. In this process, it is determined whether the CPU 106 has received a signal from the start switch 27 or not.

If the CPU 106 determines that the start switch 27 has not been pushed down yet, then the routine returns to step S11. In such a case, for example, if the CPU 106 received no signal from the start switch 27 but an indication of ending the slot game, then it is executed to cancel the calculation (subtraction) result about the number of credits at step S11.

If it is determined at step S14 that the start switch (i.e. spin button) 27 has been operated by the player, then the routine goes to step S15 where the symbols to be stopped and displayed are determined. In this determination process, the CPU 106 executes a stop-symbol determination program stored in the ROM 108 to determine the symbols to be stopped and displayed in the display areas q11 to q53. In detail, the CPU 106 executes a random number generating program to select a random number within the numerical range of 0 to 255 with respect to each display area q11 to q53 and further determine the corresponding symbol with reference to a coordinate diagram between the random numbers and the symbols stored in the ROM 108.

At next step S16, the CPU 106 executes a symbol varying and displaying process. In the process, the symbol varying and displaying is started and subsequently stopped in each display area q11 to q53. In this way, the symbols are stopped and displayed in the display areas q11 to q53.

After completing the symbol varying and displaying process, the routine goes to step S17 where the CPU 106 determines whether a winning about the pay-line has occurred or not. In other words, it is executed to determine whether the condition to generate a winning about the pay-line has been satisfied or not. At step S17, the CPU 106 refers to the pay-line information (representing the activated pay-lines corresponding to the number of medals on bet) stored in the pay-line information storing area 110C (see FIG. 5) of the RAM 110 and also refers to the payout table of FIG. 6. In these symbols stopped and displayed in the display areas q11 to q53, if there is the same kind of symbols stopped on the activated pay-line(s), then the CPU 106 determines which of various kinds defined on the payout table is identical to the above kind of stopped symbols.

Then, if the symbols stopped and displayed on the activated pay-line are of the same kind, and it is included in various kinds of symbols registered on the payout table of FIG. 6 in advance, the CPU 106 determines that the winning about the pay-line has been realized.

At step S18, it is executed to determine whether or not three or more scatter symbols are contained in the symbols displayed in the display areas q11 to q53 while referring to the payout table of FIG. 7. That is, the CPU 106 determines whether the condition to generate a winning about the scatter symbol has been satisfied or not.

If theses scatter symbols are contained in the symbols displayed in the display areas q11 to q53, the CPU 106 determines that the winning about the scatter symbol has been realized.

At step S19, it is executed to determine whether the winning has been realized at step S17 and/or step S18. If the determination at step S19 is “Yes”, then the routine goes to step S20 where the payout corresponding to the winning is read out from the payout tables (FIGS. 6 and 7) of the ROM 108 and paid out to the player.

On the contrary, if neither the winning about the pay-line nor the winning about the scatter symbol is realized, the determination of “No” is delivered at step S19, and the routine returns to step S11 to execute the next slot game.

At step S20, it is executed to distribute the payout corresponding to the result of determination for the winning at step S19. In this process, the CPU 106 adds the payout (number of credits) as a result of winning to the number of existing credits stored in the credit number storing area 110A of the RAM 110.

After completing the payout operation, the routine goes to step S21 where it is determined whether or not a bonus trigger has been effected on the basis of the symbols displayed in the display areas q11 to q53 while referring to the payout table of FIG. 6. In detail, when the specified symbols (i.e. bonus symbols) are successively displayed in the display areas q12, q22 and q32 on the pay-line L2 under the conditions defined on the payout table of FIG. 6, the CPU 106 determines that the bonus trigger has been effected. If the determination at step S21 is “Yes”, then the routine goes to step S22 to execute the process of bonus game. It is noted that the display areas q12, q22 and q32 displaying the specified symbols have possibilities of changing to the special symbols in the bonus game at first.

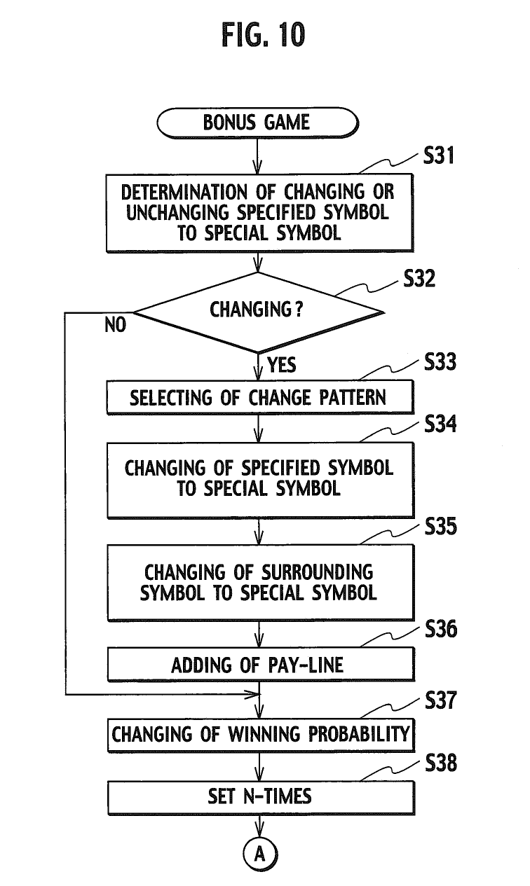

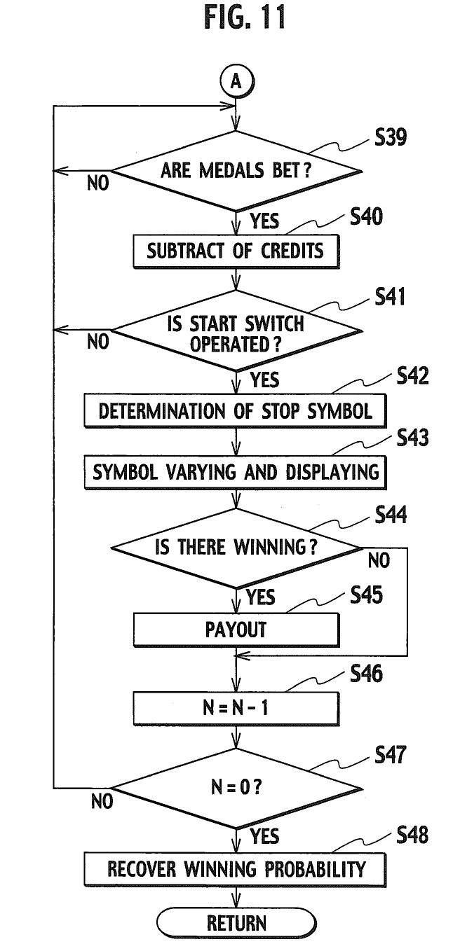

In the bonus game, a gaming advantageous to the player is repeated by a predetermined number of times. FIGS. 10 and 11 are flow charts showing the procedure of the bonus game operation at step S22. If the determination at step S21 is “Yes”, then the routine goes to step S22 where the CPU 106 operates the slot machine 10 in the bonus gaming mode from step S31.

At step S31, by the CPU 106, it is executed to determine whether, in the symbols displayed in the display areas q11 to q53 (i.e. the symbols displayed in the display areas q12, q22 and q32), the specified symbols forming the trigger for bonus game should be changed to the special symbols or not, at random.

At next step S32, the CPU 106 detects the result of determination at step S31. If it has been determined at step S31 to change the specified symbols (bonus symbols) to the special symbols, then the routine goes to step S33 with the determination of “Yes” at step S32. On the contrary, if it has been determined not to change the specified symbols (bonus symbols) to the special symbols, then the routine goes to step S37 with the determination of “No” at step S32. Subsequently, the bonus game accompanied with no change for the special symbol is carried out.

At step S33, it is executed to select, in the display areas surrounding the display areas q12, q22 and q32, display areas for changing the present symbols to the special symbols from several patterns of FIGS. 8A to 8D.

At step S34, it is executed to change the specified symbols in the display areas q12, q22 and q32 to the special symbols. At sequent step S35, it is executed to also change the present symbols in the display areas selected at step S33 to the special symbols. In this way, the special symbols are displayed over the first region 15A consisting of the display areas q11 to q53. For instance, if the pattern of FIG. 8A is selected, the special symbol is also displayed in the area (display area Q30 in the second region 15B) above the first pay-line L1.

Consequently, as shown in FIGS. 1B and 1C, there can be performed an effect of: first changing the specified symbols as the trigger for the bonus game to the special symbols; secondly changing the symbols in the circumference of the special symbols to the special symbols; and simultaneously displaying the special symbol in the display area of the second region 15B.

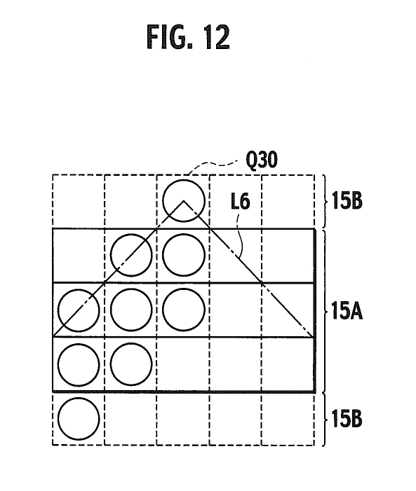

After providing the effect display, the routine goes to step S36 where the CPU 106 increases the pay-lines in each slot game during the bonus gaming mode on the basis of the pattern selected at step S33. In detail, it is assumed that the pattern of FIG. 8A (i.e. the case of FIG. 1C) is selected at step S33. Then, the special symbols are displayed not only in some display areas of the first region 15A but also in the display area Q30 of the second region 15B. Thus, when the special symbol appears in the second region 15B, the CPU 106 additionally sets a new pay-line containing a new display area having the special symbol displayed therein, as a candidate pay-line to be selected corresponding to the number of medals on bet. In case of the pattern of FIG. 8A, as shown in FIG. 12, a new pay-line L6 containing the display area Q30 of the second region 15B is additionally set as the candidate pay-line for selection. Then, the ROM 108 stores the information about the position of the pay-line L6 in advance, while the CPU 106 sets information for making the pay-line L6 valid as a selective object in the RAM 110.

In this way, according to the embodiment, the new pay-line is set as the candidate pay-line for selection corresponding to the number of betting medals owing to the change (transformation) of the surrounding symbols to the special symbols. This new pay-line can be set corresponding to the number of medals on bet at step S39 mentioned later. Incidentally, if the new pay-line is set as the candidate pay-line for selection, a special symbol acting as the trigger of validating the new pay-line (e.g. the special symbol displayed in the area Q30) is displayed. When this special symbol is a symbol playing respective roles of the other symbols, the probability of winning related to the pay-line set as the candidate pay-line for selection is raised.

We refer to FIG. 10 again. At step S37, by the CPU 106, it is executed to change a weighted data pre-set in the ROM 108 to a second weighted data for use in the bonus gaming mode. Consequently, the probability that the scatter symbol is selected is enhanced in the bonus game.

At step S38, by the CPU 106, it is executed to set the number N of times when the bonus game is performed by the slot machine 10 in the RAM 110. It is noted that the above number N is determined in advance.

At step S39 (FIG. 11), it is executed to determine whether medal(s) have been bet by the player or not. This step is similar to step S11 of FIG. 9. If the determination at step S39 is “Yes”, that is, in the situation that the medals have been bet, then the routine goes to step S40 to subtract the number of medals (credits) on bet from the credit number stored in the ROM 110. This process is similar to that at step S12 of FIG. 9.

At step S41, it is executed to determine whether the start switch 27 has been operated by the player or not. If the start switch 27 has been operated (“Yes” at step S41), the routine goes to step S42. At step S42, on selecting a random number under the winning probability (the second weighted data) set at step S37, it is executed to determine stop symbols to be stopped in respective display areas except the display areas presently displaying the special symbols.

Upon determination of the symbols to be stopped, the routine goes to step S43 where the CPU 106 causes the liquid crystal display 16 to display varying symbols in the respective display areas except the display areas displaying the special symbols. At step S44, it is executed to determine whether or not the winning related to the pay-line has been realized depending on the kinds of symbols stopped and displayed on the activated pay-lines and additionally, the winning has been realized based on the combination of symbols stopped and displayed (i.e. number of identical scatter symbols). In this process, the CPU 106 identifies the special symbol whose varying and displaying is stopped, as a symbol playing respective roles of all other kinds of symbols.

In this case, the CPU 106 determines the occurrences of both the winning related to the pay-line and the winning related to the scatter symbol, on the ground of the payout table about pay-line of FIG. 6 and the payout table about scatter symbol of FIG. 7. On the payout table about pay-line, there are defined various condition of generating the winnings about the pay-lines and their payouts. Similarly, on the payout table about scatter symbol, there are defined various condition of generating the winnings about the scatter symbols and their payouts. When the wining about pay-line occurs, the CPU 106 determines a payout amount (i.e. numbers of credits) in accordance with the payout table about pay-line. When the wining about scatter symbol occurs, the CPU 106 determines a payout amount (i.e. numbers of credits) in accordance with the payout table about scatter symbol.

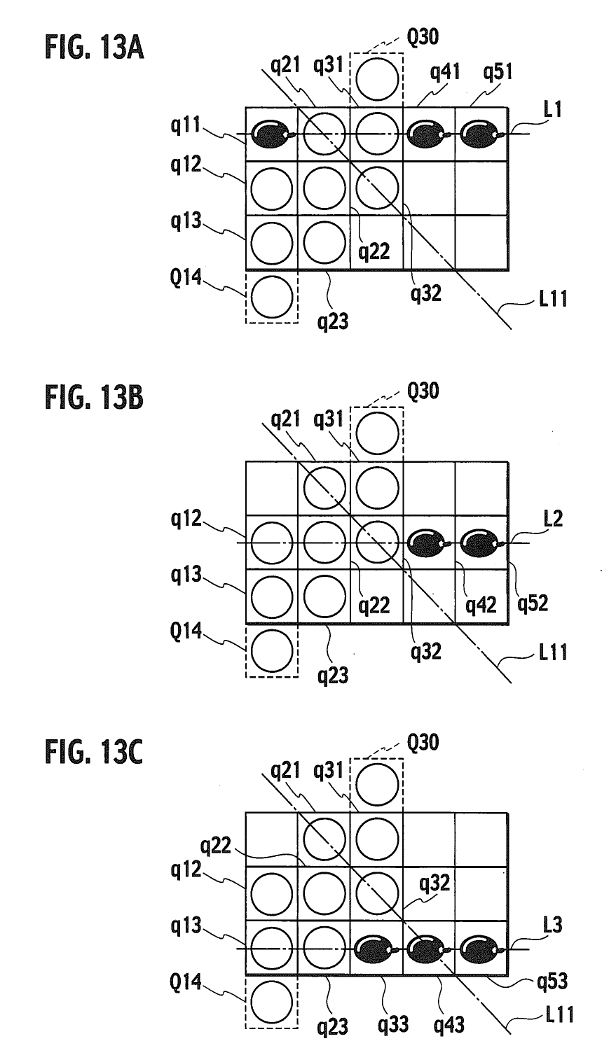

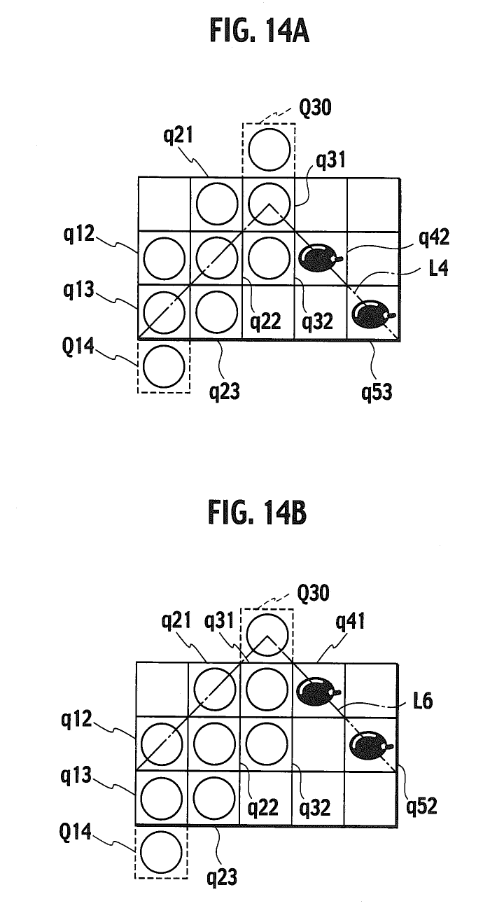

FIGS. 13A to 14B show an example of a winning about pay-line in the generating mode. In FIGS. 13A to 13C, circles shown in the display areas q12, q13, q14, q21, q22, q23, q30, q31 and q32 represent special symbols, respectively. FIG. 13A illustrates a situation where “PLUM” symbols representing plums are stopped and displayed in the display areas q11, q41 and q51. In this case, since the special symbols playing roles of all kinds of symbols, namely, “almighty” symbols are stopped and displayed in the display areas q21 and q31, the winning about the pay-line L1 is realized. FIG. 13B illustrates a situation where “PLUM” symbols representing plums are stopped and displayed in the display areas q42 and q52. In this case, since the almighty special symbols are stopped and displayed in the display areas q12, q22 and q32, the winning about the pay-line L2 is realized. FIG. 13C illustrates a situation where “PLUM” symbols representing plums are stopped and displayed in the display areas q33, q43 and q53. In this case, since the special almighty symbols are stopped and displayed in the display areas q13 and q23, the winning about the pay-line L3 is realized. FIG. 14A illustrates a situation where “PLUM” symbols representing plums are stopped and displayed in the display areas q42 and q53. In this case, since the special almighty symbols are stopped and displayed in the display areas q13, q22 and q31, the winning about the pay-line L4 is realized. FIG. 14B illustrates a situation where “PLUM” symbols representing plums are stopped and displayed in the display areas q41 and q52. In this case, since the special almighty symbols are stopped and displayed in the display areas q12, q21 and Q30, the winning about the pay-line L6 is realized. Throughout FIGS. 13A to 14B, it is assumed that other kinds of symbols irrelevant to the generation of winning are stopped and displayed in the other display areas with blanks.

If no winning is generated, that is, in case of the determination “No” at step S44, the routine goes to step S46. On the contrary, if the determination at step S44 is “Yes” (generation of winning), then the routine goes to step S45 where the CPU 106 carries out payout of credits corresponding to the winning result. At next step S46, it is executed to subtract one from the number N (i.e. N=N−1). At step S47, it is executed to determine whether the calculation at step S46 results in zero (0) or not. If the determination at step S47 is “No”, that is, the present number of times of playing the bonus game has not reached the predetermined number yet, then the routine returns to step S39 where the CPU 106 performs the next bonus game. On the contrary, if the determination at step S47 is “Yes”, that is, the CPU 106 has already performed the bonus game in the prescribed number of times, the routine goes to step S48 to change the weighted data on use from the second weighted data for bonus game to the first weighted data for normal game, reducing the winning probability for the normal game. After completing the process at step S48, by the CPU 106, the routine returns to the process for the normal game of FIG. 9.

As mentioned above, the slot machine 10 of the embodiment operates is constructed so that when the specified symbols acting as a trigger for the bonus game change to the special symbols, the symbols in the circumference of the special symbols also change to the special symbols. Thus, as the special symbols are arranged in concentration and succession on the basis of the display areas displaying the specified symbols, it becomes possible to accomplish effect display to raise a player's sense of anticipation about the situational change of game.

In the above-mentioned embodiment, when the special symbol is displayed in the second region 15B, the new pay-line L6 in accordance with the specific position (e.g. the display area Q30) in the second range 15B is newly set as the candidate to be selected in response to the number of credits on bet. However, the present invention is not limited to this, but a new special symbol may be displayed in an extension of the existing pay-line at step S35 in the modification. As shown in FIGS. 13A to 13C, for example, it is assumed that an oblique pay-line L11 is set as the candidate to be selected in response to the number of credits on bet. Under condition of allowing the display area Q10 in the second region 15B in the direction of the pay-line L11 to display a special symbol, if the same kind of symbols are aligned in the display areas Q10, q21, q32, and q43, the player may be awarded with a bigger winning than the winning provided in aligning the same kind of symbols in the display areas q21, q32 and q43.

Further, in the above-mentioned embodiment, the specified symbols acting as the trigger for the bonus game are changed to the special symbols. However, the present invention is not limited to this, but it may be modified so that when the specified symbols are aligned, some (predetermined number) of symbols stopped and displayed in the other display areas are changed to the special symbols and additionally, symbols in the circumference of the so-changed special symbols are also changed to special symbols.

Further, in the above-mentioned embodiment, the display areas in the circumference of the specified symbols after changing to the special symbols are adapted so as to display the special symbols on selecting any of the patterns shown in FIGS. 8A to 8D. However, the present invention is not limited to this, but it is possible to adopt other various patterns. For example, there may be adopted a pattern allowing the special symbols to spread in the transverse direction of the display unit or another pattern allowing the special symbols to spread radially outward.

In connection, alternatively, the above display areas for changing the specified symbols to the specified symbols may be determined at random with respect to each change.

While the present invention has been described by way of the above-mentioned embodiment where a liquid crystal display is adopted as the display unit for displaying symbols, it is to be understood that the display unit is not limited to the liquid crystal display, but various other display units, such as display unit using EL (Electro Luminescence), are applicable to the display unit of the present invention.

What is claimed is:

1. A slot machine comprising:
a display unit on which a slot game is performed, wherein the slot game is programmed so that one symbol is selected from among multiple kinds of symbols and displayed in each of first display areas of the display unit; and
a controller that performs the slot game on the display unit, wherein, when symbols displayed in two or more first display areas form a predetermined combination, the controller changes a predetermined number of the symbols to special symbols advantageous to a player and further changes symbols adjacent to the special symbols to special symbols advantageous to the player.

2. The slot machine of claim 1, wherein
the display unit has a second display area other than the first display areas on each of which the one symbol is displayed, and
the controller displays a special symbol advantageous to the player on the second display area when an area adjacent to first display areas on which the predetermined number of the symbols are changed to the special symbols is positioned outside the first display areas.

3. The slot machine of claim 1, wherein
the controller shifts the slot game to a game advantageous to the player when a combination of symbols displayed on two or more first display areas fulfils a predetermined condition for shifting to the game advantageous to the player, and
when symbols displayed on two or more first display areas form the predetermined combination in the game advantageous to the player, the controller randomly determines whether or not a predetermined number of the symbols are changed to special symbols advantageous to the player.

4. The slot machine of claim 3, wherein
the controller selects one symbol from among the multiple kinds of symbols and displays the one symbol in each of first display areas other than first display areas on which the symbols are changed to the special symbols, while maintaining the display of the special symbols.

5. The slot machine of claim 1, wherein
the special symbols are symbols each playing respective roles of the multiple kinds of symbols.

6. The slot machine of claim 4, wherein
the special symbols are symbols each playing respective roles of the multiple kinds of symbols.

7. A slot machine comprising:
a display unit on which a slot game is performed, wherein the slot game is programmed so that one symbol is selected from among multiple kinds of symbols and displayed in each of first display areas of the display unit and a winning occurs based on a combination of symbols displayed on a predetermined pay-line set through the first display areas; and
a controller that performs the slot game on the display unit, wherein, when symbols displayed in two or more first display areas form a predetermined combination, the controller changes a predetermined number of the symbols to special symbols advantageous to a player and further changes symbols adjacent to the special symbols to special symbols advantageous to the player.

8. The slot machine of claim 7, wherein
the display unit has a second display area other than the first display areas on each of which the one symbol is displayed, and
the controller displays a special symbol advantageous to the player on the second display area when an area adjacent to first display areas on which the predetermined number of the symbols are changed to the special symbols is positioned outside the first display areas.

9. The slot machine of claim 7, wherein
the display unit has second display areas other than the first display areas on each of which the one symbol is displayed, and
the controller displays a special symbol advantageous to the player on a second display area which is arranged in an extension direction of the pay-line when an area adjacent to first display areas on which the predetermined number of the symbols are changed to the special symbols is positioned outside the first display areas.

10. The slot machine of claim 7, wherein
the display unit has second display areas other than the first display areas on each of which the one symbol is displayed, and
the controller displays a special symbol advantageous to the player on a second display area through which a new pay-line is set when an area adjacent to first display areas on which the predetermined number of the symbols are changed to the special symbols is positioned outside the first display areas.

11. The slot machine of claim 7, wherein
the controller shifts the slot game to a game advantageous to the player when a combination of symbols displayed in two or more first display areas fulfils a predetermined condition for shifting to the game advantageous to the player, and
when symbols displayed on two or more first display areas form the predetermined combination in the game advantageous to the player, the controller randomly determines whether or not a predetermined number of the symbols are changed to special symbols advantageous to the player.

12. The slot machine of claim 11, wherein
the controller selects one symbol from among the multiple kinds of symbols and displays the one symbol in each of first display areas other than first display areas on which the symbols are changed to the special symbols, while maintaining the display of the special symbols.

13. The slot machine of claim 7, wherein
the special symbols are symbols each playing respective roles of the multiple kinds of symbols.

14. The slot machine of claim 12, wherein
the special symbols are symbols each playing respective roles of the multiple kinds of symbols.

15. A control method of a slot machine comprising:
performing a slot game in which one symbol is selected from among multiple kinds of symbols and displayed on each of display areas;
changing a predetermined number of symbols displayed in two or more display areas to special symbols advantageous to a player when the symbols form a predetermined combination; and
changing symbols adjacent to the special symbols to special symbols advantageous to the player.
